(19) United States
(12) Patent Application Publication
(10) Pub. No.: US 2007/0272372 A1
(43) Pub. Date: Nov. 29, 2007

(54) Multi-Fold Door and Window Assemblies

(76) Inventor: Michael Glover, Hamilton (NZ)

Correspondence Address: DICKSTEIN SHAPIRO LLP, 1825 EYE STREET NW, Washington, DC, 20006-5403, US

(21) Appl. No.: 10/576,076

(22) PCT Filed: Oct. 14, 2004
(86) PCT No.: PCT/NZ04/00256

§ 371 Date: Mar. 12, 2007

(30) Foreign Application Priority Data
Oct. 14, 2003 (NZ) 528921

(51) Int. Cl. E05D 15/26

(52) U.S. Cl. 160/206

(57) ABSTRACT

A multi-fold leaf (30,31) joinery assembly has a joinery bogey unit (2) that is pivotally connected to a joinery leaf. A seal (20) is provided on a moveable edge of the leaf adjacent to the bogey unit, the seal being adjacent to a frame seal (25) for a head or sill of a frame of the assembly when the at least one leaf is in a closed position. The pivot connection is off-set so that the seal moves away from the frame seal when the leaf is opened, thus avoiding scrubbing.

### FIELD OF THE INVENTION

This invention relates to a multi-fold leaf joinery assemblies, that is to say folding door or window assemblies which have multiple door or window leaves that are pivotally inter-connected. The leaves in such assemblies fold relative to each other as the door or window is opened, and unfold as the door or window is closed.

### BACKGROUND TO THE INVENTION

Multi-fold leaf assemblies, such as so called “bi-fold” door assemblies, for example, suffer a number of problems.

The most significant problem is the scrubbing that occurs between the frame seal on the frame head or sill and seals on vertical edges of the leaves of the assembly. Scrubbing eventually results in worn seals which inevitably require replacement. It can also result in damage to the door or window leaf itself.

Structural problems also exist with known arrangements. One of these is the provision of roller or bogey units on one side of an upper or lower leaf rail or at the top or bottom of a stile. Since these bogey units are off-centre, distortion of the leaf tends to occur over time. The position of the bogey or roller unit also tends to adversely affect aesthetics of the assembly.

The roller or bogey units that are currently used work in conjunction with a track that is provided in the frame or as an attachment to the frame. This allows the leaves to be wheeled or rolled along the track to allow them to fold relative to each other during opening, and to unfold during closing. Tracks are prone to contamination from debris such as stones, grit and dust which tend to collect on or in the track and interfere with the movement of the bogey or roller unit. Apart from making operation of the assembly difficult, debris in the track or channel can damage the bogey or roller unit and significantly reduce the life span of the assembly.

Multi-fold leaf assemblies also present security problems when trying to maintain the leaves in any position apart from a fully closed position.

### OBJECT OF THE INVENTION

It is an object of the present invention to provide multi-fold leaf joinery apparatus or a multi-fold leaf joinery assembly that overcomes one or more disadvantages of known apparatus or assemblies.

It is another object of the invention to provide bogey or roller unit apparatus for multi-fold leaf joinery apparatus that overcomes one or more disadvantages of known apparatus.

Alternatively, it is an object of the invention to at least provide the public with a useful choice.

Other objects of the invention will become apparent from the following description, which is given by way of example only.

### SUMMARY OF THE INVENTION

Accordingly, in one aspect the invention consists in a joinery bogey for a multi-fold joinery leaf assembly having a plurality of joinery leaves provided in

a frame, the joinery bogey including:

a body adapted to travel along a track mounted on the frame;

a pivot mount provided on the body for a pivot connection between the body and at least one of the leaves, the at least one leaf having a moveable edge proximal to the bogey, the moveable edge being provided adjacent to a frame seal for a head or sill of the frame when the at least one leaf is in a closed position, and the pivot connection being located so that the moveable edge has a component of movement away from the frame upon initiation of opening of the at least one leaf.

In a preferred embodiment a wall segment is provided on the body for location adjacent to the frame seal, and the at least one leaf being disposed about a periphery of the wall segment when the at least one leaf is in the closed position, the moveable edge comprising a part of the periphery.

In a preferred embodiment the bogey is pivotally connected to the at least one leaf and regions of the leaf adjacent to the periphery of the wall segment are contoured or recessed such that the wall is substantially accommodated by the leaf when the leaf is in the closed position so that a substantially continuous planar surface is provided adjacent to the frame seal.

The wall segment may have at least one vertical side and the moveable edge may be provided adjacent to the vertical side, the vertical side being horizontally displaced from the pivot connection.

Preferably the wall segment includes two horizontal sides, one horizontal side being disposed above the level of the frame seal and the other horizontal side being disposed below the level of the frame seal.

The movement of the moveable edge away from the frame upon initiation of opening of the at least one leaf preferably substantially prevents scrubbing between the moveable edge and the frame seal. The moveable edge may comprise at least part of a seal provided on the at least one leaf.

In a preferred embodiment the body includes one or more wheels which may rotate through an arc of movement in a plane perpendicular to the direction of travel of the bogey unit along the frame.

In a second aspect the invention consists in A multi-fold, joinery leaf assembly having two or more door or window leaves pivotally connected together about a vertical axis, a bogey unit pivotally connected to at least one of the leaves about a vertical axis and being adapted to travel along a track mounted on a frame, the at least one leaf having a moveable edge proximal to the bogey, the moveable edge being provided adjacent to a frame seal for a head or sill of the frame when the at least one leaf is in a closed position, and the pivot connection being located so that the moveable edge has a component of movement away from the frame upon initiation of opening of the at least one leaf.

In a preferred embodiment the bogey unit is provided with a wall segment for location adjacent to the frame seal, and the at least one leaf is disposed about a periphery of the wall segment when the at least one leaf is in the closed position, the moveable edge comprising a part of the periphery.

In a preferred embodiment regions of the at least one leaf adjacent to the periphery of the wall segment are contoured or recessed such that the wall is substantially accommodated by the leaf when the leaf is in the closed position so that a substantially continuous planar surface is provided adjacent to the frame seal.

The wall segment may have at least one vertical side and the moveable edge may be provided adjacent to one of the vertical sides, the vertical side being horizontally displaced from the pivot connection between the bogey and the at least one leaf.

Preferably the wall segment includes two horizontal sides, one horizontal side being disposed above the level of the frame seal and the other horizontal side being disposed below the level of the frame seal.

The track is preferably provided in a sill of the frame and the at least one leaf is provided directly over the track.

The bogey unit may include the pivot connection, and the bogey unit may further include one or more stile or rail engaging arms which connect the bogey unit to a stile or rail of the at least one leaf.

The assembly may comprise a plurality of extruded components.

Preferably, the track is replaceable in the frame.

In a preferred embodiment the movement of the moveable edge away from the frame upon initiation of opening of the at least one leaf substantially prevents scrubbing between the moveable edge and the frame seal.

The moveable edge preferably comprises at least part of a seal provided on the at least one leaf.

The bogey unit may include one or more wheels which may rotate through an arc of movement in a plane perpendicular to the direction of travel of the bogey unit along the frame.

In a third aspect the invention consists in a joinery bogey for a multi-fold joinery leaf assembly, the bogey unit including:

a track movement means to allow the bogey to move along a track;

a pivot assembly pivotally connecting a stile or rail engaging arm to the bogey unit, each stile or rail engaging arm being adapted to be attached to a stile or arm of a joinery leaf.

A further stile or rail engaging arm may be pivotally connected to the bogey unit by the pivot assembly.

The stile or rail engaging arm is preferably adapted to be attached to the stile or rail of a leaf by being received within a cavity provided in the stile or rail.

In a fourth aspect the invention consists in a track assembly for a multi-fold joinery leaf installation having an extruded frame member with a recess adapted to receive a track, the track being insertable and removable to and from the recess and having at least one wall defining a central cavity and two edges, at least one of the edges being adapted to support a bogey unit.

Preferably the at least one edge includes a lip or bead providing a substantially convex surface.

In a preferred embodiment the track includes a coating to reduce wear.

The track may be formed from a different material than the frame.

Optionally, the frame member is formed from aluminum and the track is formed from stainless steel.

The cavity is preferably adapted to accommodate a guide member dependent from the bogey unit.

Optionally, the bogey unit is provided clear of a base of the cavity so that the cavity in use allows particulate matter to fall therein so as to prevent the particulate matter from interfering with movement of the bogey unit along the track.

In a fifth aspect the invention consists in a bogey unit a joinery bogey for a multi-fold joinery leaf assembly having a plurality of joinery leaves provided in a frame, the joinery bogey including:

a body having one or more wheels to allow the unit to travel along a track mounted on the frame, and means to allow the one or more wheels to rotate through an arc of movement in a plane perpendicular to the direction of travel of the bogey unit along the frame.

The invention also consists in a kit of parts for any one of the apparatus or constructions according to the foregoing aspects.

Further aspects to the invention, which should be considered in all its novel aspects, may become apparent from the following description which is given by way of example only and with reference to the accompanying drawings.

### BRIEF DESCRIPTION OF THE DRAWINGS

FIG. 1 is a partial perspective view from below of two adjacent leaves of a folding door assembly in a closed position.

FIG. 2 is a perspective view of a part of a bogey or carriage unit which is partially shown in FIG. 1

FIG. 3 is a partial perspective view of the exterior of the assembly of FIG. 1 again shown in the closed position

FIG. 4 is a partial perspective view of the interior of the assembly shown in FIG. 3, in which part of the bogey unit may also be seen.

FIG. 5 is a side elevation and cross section of the lower or bottom track assembly of the folding door assembly of the preceding figures.

FIG. 6 is a side elevation and cross section of the top track or rail assembly of the folding door assembly of the preceding Figures

FIG. 7 is a perspective view of the assembly of FIG. 1 in a closed configuration, but with the structure of the joinery leaves removed.

FIG. 8 is a further perspective view of the construction shown in FIG. 7, but in a partly open position.

FIG. 9 is a further perspective view of the construction of FIGS. 7 and 8 in a partially open position which is more open than that shown in FIG. 8.

FIG. 10 is a partial perspective view of the construction of FIGS. 7 to 9, but in a fully open position.

FIG. 11 is a partial perspective view from below of an alternative embodiment of a multi-folding joinery leaf assembly in which the edges of two adjacent leaves are shown disposed in the closed position in which the edges abut each other, such as may occur at an even leaf configuration of a multi-fold assembly.

FIG. 12 is a partial perspective view from below of a further alternative embodiment of the invention showing an edge of a leaf in a closed position in which it abuts a stationary member such as a frame member or mullion. This configuration is one which typically occurs in an odd and even leaf multi-fold assembly.

FIG. 13 is a diagrammatic partial plan view of the assembly of FIG. 1 showing a sequential opening of the hingedly connected leaf members.

FIG. 14 is a perspective view from below of a bogey unit including an alternative wheel assembly.

FIG. 15 is a further perspective view from below of the wheel assembly shown in FIG. 14.

FIG. 16 is a partial perspective view of the unit of FIGS. 14 and 15, showing a chassis and axle.

FIG. 17 is a partial perspective view of the unit of FIGS. 14, 15 and 16, showing an axle and wheel.

### DETAILED DESCRIPTION

The invention will now be described with reference to a number of preferred embodiments.

As a person skilled in the relevant art will appreciate, reference in this document to leaves refers to the folding elements such as panels (which may be glazed) including door panels or windows, for example. References in this document to multi-fold leaf assemblies include assemblies such as those commonly referred to as bi-fold door assemblies, i.e. those having two or more folding leaves. When these assemblies are in the closed position, the leaves are aligned so as to be parallel to the plane of the building opening in which they are disposed. In an open position or configuration the panels are disposed at an angle to the plane of the opening. In a fully open position the leaves are substantially perpendicular to the plane of the opening.

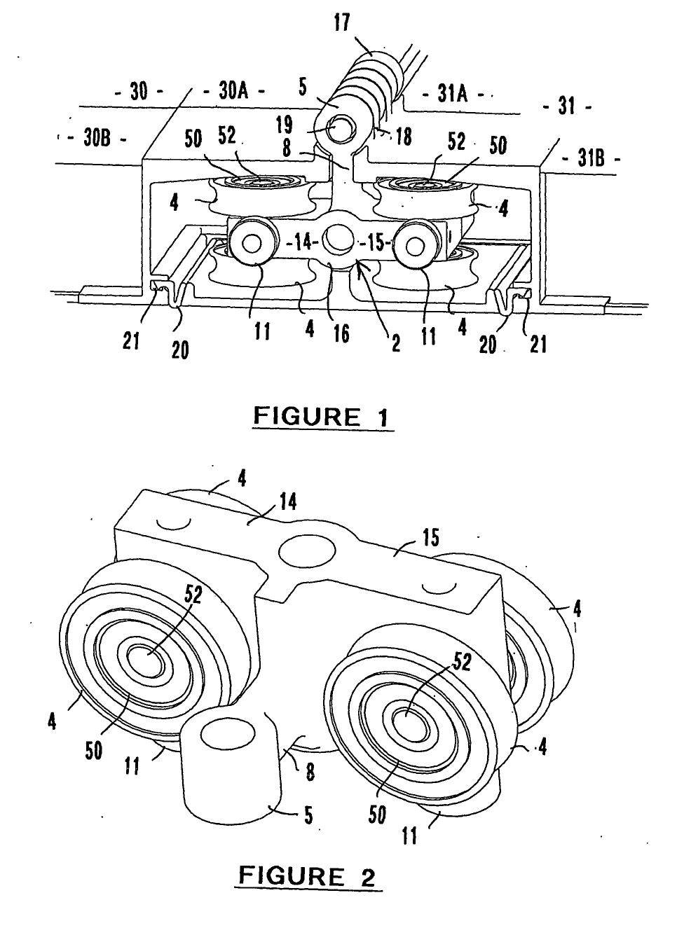

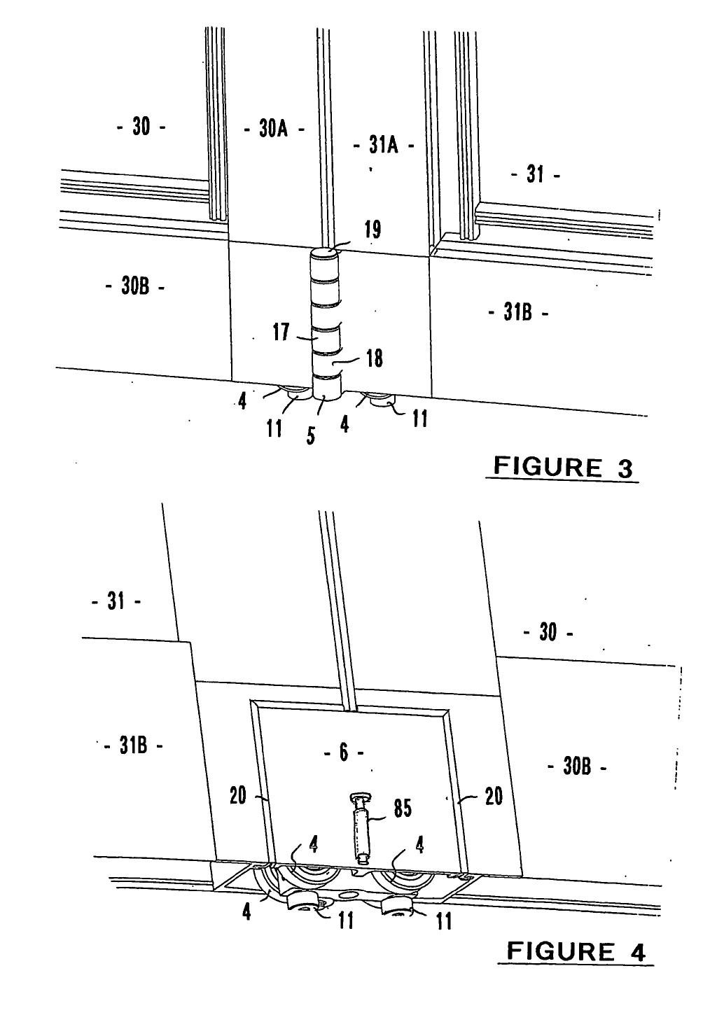

Referring to FIG. 1, two adjacent leaves, generally referenced 30 and 31 are shown. The leaf 30 has a stile or mullion 30a and leaf 31 has a stile or mullion 31a. Although the assembly could be suspended from a track in the head of the frame, the arrangement shown in FIG. 1 is preferred and that is further described below.

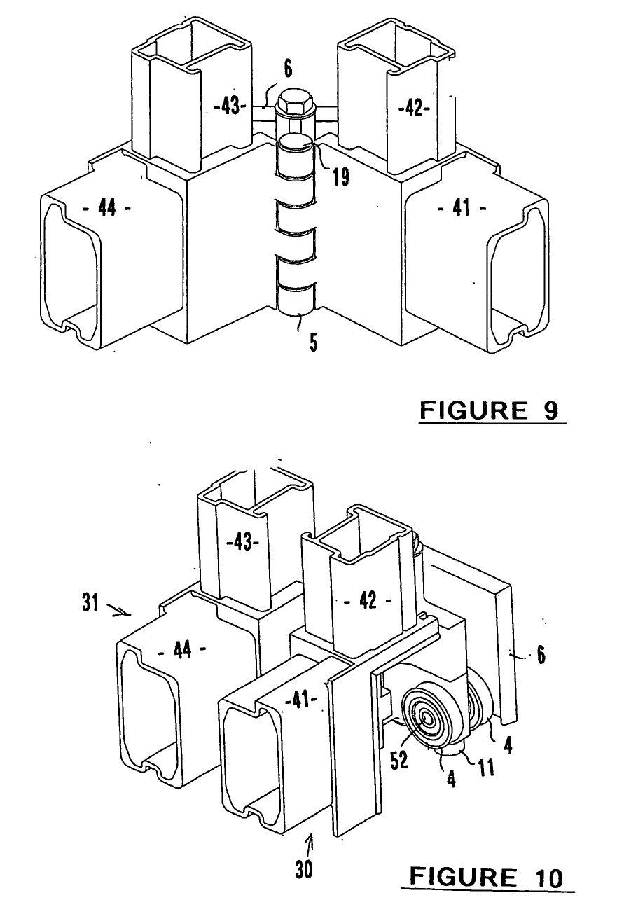

As illustrated in FIG. 1, a bogey unit which is generally referenced 2 is provided at the base of stiles 30a and 31a or at the inner edges of lower rails 30b and 31b of the adjacent leaves. Thus the bogey unit 2 can be provided as an integral part of the leaf structure, or can be provided as a completely separate component. Also, as illustrated in FIGS. 7 to 10, the bogey unit may be provided as a structural unit having mounting arms for engagement with one or both of the stiles or rails of each leaf.

The bogey unit preferably has a frame or chassis which may be provided as a unitary member, for example being cast or moulded or extruded. The frame generally includes elongate portions 14 and 15 and a pivot mounting structure which may be in the form of pivot arm 8 which supports a pivot base 5. Provided on the frame are one or more wheels or rollers 4 mounted relative to the frame by bearings 50 which may be supported by axles 52. Guide rollers 11 may also be provided to assist guiding the bogey unit in a track as will be further described below.

Referring to FIG. 1, the pivot base 5 is provided on a pivot arm 8, which extends outwardly from the frame of the bogey unit. Arms 17, 18, which are dependant from the leaves 30, 31, co-operatively engage with the pivot support 5 to form a barrel in which pin 19 is inserted. Together these components form the pivotal (or hinged) connection between the bogey unit and the adjacent leaf or leaves.

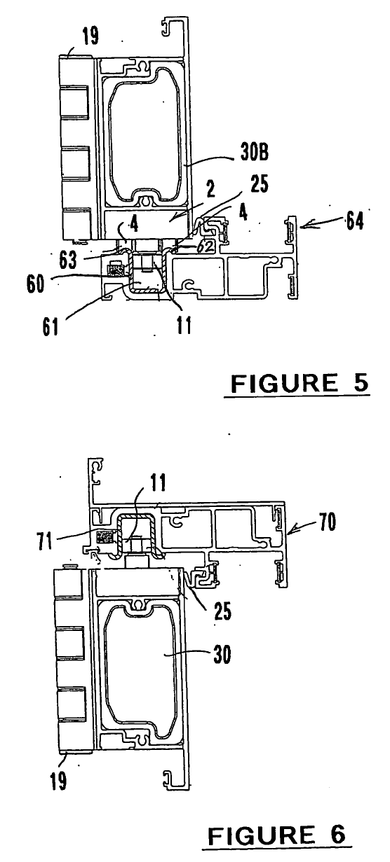

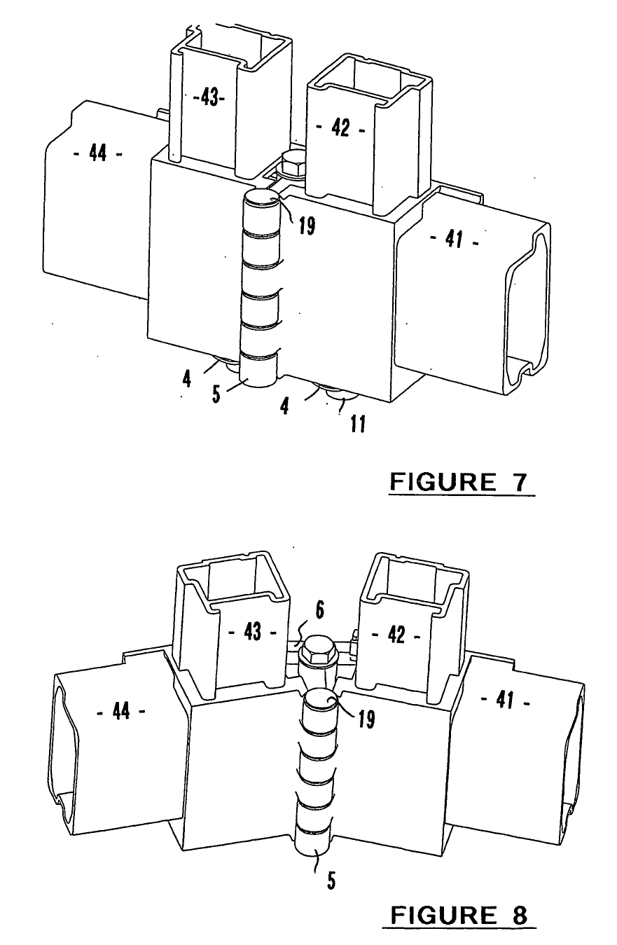

A wall segment 6 is also mounted dependent from the frame of the bogey unit such that it extends parallel to the bogey unit, i.e. parallel to the frame and the plane of the opening in which the unit is disposed in use. The wall segment 6 will contact a frame seal 25 (refer to FIGS. 5 and 6) on the sill and/or the head of the frame, simply sliding along the seal in use as the assembly is opened or closed. This occurs because the wall segment remains stationary relative to the frame of the bogey unit. This is seen more clearly in FIGS. 7 to 10.

The lower parts of the stiles (or mullions) and the rails of the leaf members are recessed, apertured or otherwise formed so as to accommodate the wall segment 6. Seals 20 are provided on the edges of the leaves so that sealing contact is made between the leaves and the peripheral edges of wall segment 6 when the assembly is in the closed position, as can be seen in FIG. 4. Seals 20 may alternatively be dependent from the peripheral edges of the wall segment 6.

In FIG. 5 the sill construction for a preferred embodiment is shown in cross section. The sill frame part 64 includes a track or rail in the form of a channel 60 having a cavity 61 with upper edges that are rolled to form lips 62 and 63 on which the wheels 4 move in use.

The wheels (or rollers) 4 have a concave outer surface which engages with lips 62 and 63 to assist the rollers to follow the lips 62 and 63 of the track in use. The guide roller 11 rests within an upper part of the cavity 61 of the track to provide further lateral support which prevents the bogey from becoming disengaged or derailed from the track.

The cavity 61 provided in the track allows debris, especially particulate matter such as stones, dirt and dust, to collect in the base of the channel. As can be seen, the bogey unit rests some distance above the base, so that debris that collects in the base is very unlikely to interfere with the movement of the bogey unit along the track.

The frame 64 may be constructed from a variety of different materials. As illustrated in FIG. 5, a preferred form of the sill is an extrusion, such as an aluminum extrusion (although other materials such as plastics could be used), and the frame 64 on which the multi-fold assembly is mounted includes the track 60 which is advantageously replaceable within the frame. This allows the track to be replaced if it becomes worn, so that the entire frame sill does not need to be removed and replaced. It also allows the track to be made of a different material, or be coated or treated differently, from that of the frame. In a preferred embodiment, the track may be anodised aluminum, which we have found to have desirable wear characteristics. In another embodiment a hard material, such as stainless steel for example, may be used to form the track. A harder material, or modified material has the advantage of a much longer service life and provides greater strength to the frame member. Because it is replaceable, the track can be removed when it is worn. The higher cost of the harder wearing track is only incurred in a small part of the frame, which is an additional advantage. The track 60 is held in place using a fastener, such as a self tapping screw (not shown) through the base of the track which does not interfere with the guide 11.

In a preferred embodiment, as shown, the bogey unit sits directly below the leaf that it supports and rests directly on top of the track 60. Therefore, the significant weight of the leaf or leaves that the bogey unit supports bears directly upon the track and thus upon the frame. This differs significantly from many existing constructions where the bogey unit is frequently attached to the side of an upper or lower rail of the leaf meaning that the weight of the leaf or leaves is not directly aligned with the track. Accordingly, distortion can occur in the leaf or frame. The alignment of forces realised with the present invention overcomes this problem.

The folding door assembly 1 preferably further includes an overhead rail. FIG. 6 illustrates a head frame part 70 which includes an overhead rail or track 71 of a preferred embodiment. The overhead track 71 preferably aligns with the bottom positioned track 60 (shown in FIG. 5) so that the track 71 and track 60 support the leaves 30, 31 in a substantially vertical alignment.

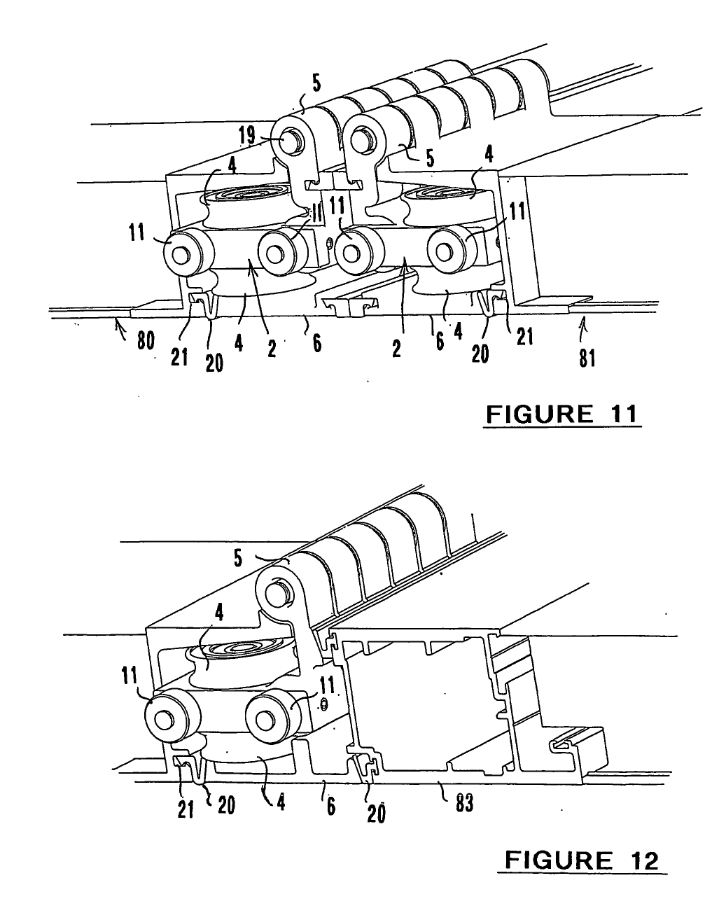

Turning to FIGS. 7 to 10, an embodiment of the invention is shown in which a structural unit is provided including a bogey or carriage and also effectively including the lower (or upper) corner or corners of a leaf or leaves that the bogey unit supports in use. These hingedly connected corner assemblies include arms or spigots 41 to 44 about which rails or stiles of the leaves can be located in order to create the required multi-fold leaf structure. Therefore, the invention also provides a structural unit which may be used to create a multi-fold leaf assembly. Although the structural unit shown in FIGS. 7 to 10 shows a structural unit for two leaf corners which are hingedly interconnected about a bogey unit, those skilled in the art will appreciate that the structural unit is also applicable to the other embodiments referred to in this document, including for example the embodiments shown in FIGS. 11 and 12.

The embodiment shown in FIGS. 7 to 10 has the advantage that it facilitates construction of a complete multi-leaf assembly from extruded aluminum components. Furthermore, the extruded aluminum components themselves have a grain and the assembly of extruded components using the structural unit shown in FIGS. 7 to 10 can provide a multi-leaf assembly which has a desirable aesthetic appearance which compares favourably with timber joinery products. This is because the grain of timber products (for example, a glazed timber multi-fold door assembly) will have stiles and rails, having a grain with a distinctive appearance. The present invention allows that appearance to be imitated, at least to a certain extent, using aluminum fabrication. The components, or some of the components, may instead be constructed using casting and/or machining processes.

Referring now to FIG. 11, another embodiment of the invention is shown. Features of the embodiment shown in FIG. 11 (and that of FIG. 12) which are the same as or similar to those of the embodiments discussed above have the same reference numerals. The construction shown in FIG. 11 shows the abutting edges of two leaves in a multi-leaf construction which has an even number of leaves. Therefore the two abutting leaves shown in FIG. 11 may typically be provided at the centre of a multi-leaf installation, the installation being opened by a user pushing the abutting edges of the leaves 80 and 81 apart so that the bogey units travel away from each other. As can be seen in FIG. 11, the bogey or carriage units have only two wheels each rather than 4, however, two guide rollers 11 are provided to assist correct retention of the bogey relative to the track. Each bogey is pivotally (i.e. hingedly) connected to the edge of its relevant leaf. Again, each bogey has a wall segment 6 that in use remains in contact with the frame seal along the sill or head of the frame.

In FIG. 12, the bogey which is hingedly connected to the edge of a leaf 82 is shown. The leaf abuts a stationary frame member 83, which is a situation that typically occurs in a multi-fold assembly with an odd number of leaves, i.e. a single leaf may abut a stationary frame member such as upright 83. Again, the wall segment 6 remains in contact with a frame seal provided at the head or sill of the frame.

In use, the wall segment 6 is adapted to co-operate with seals 20 retained in retaining grooves 21 in the sill members of the leaves 30, 31 when in a closed configuration to provide a weather seal i.e. to assist prevention of draughts/air/wind driven water movement through the multi-fold assembly 1. The seals are positioned around the sides and top edges of the wall segment 6. The seals 20 could include air seals or compression seals as would be known in the art. A further preferred option is that the seals 20 may include barbs adapted to engage with ribs of further seals on the wall 6 when the leaves 30, 31 are in a closed configuration. Thus the wall 6 effectively fills a recess provided in each panel member in the vicinity of the frame seal along the sill and head of the frame. The outer surface of wall segment 6 therefore provides a surface which contacts the frame seals along the head and sill of the frame when the assembly is in the closed position.

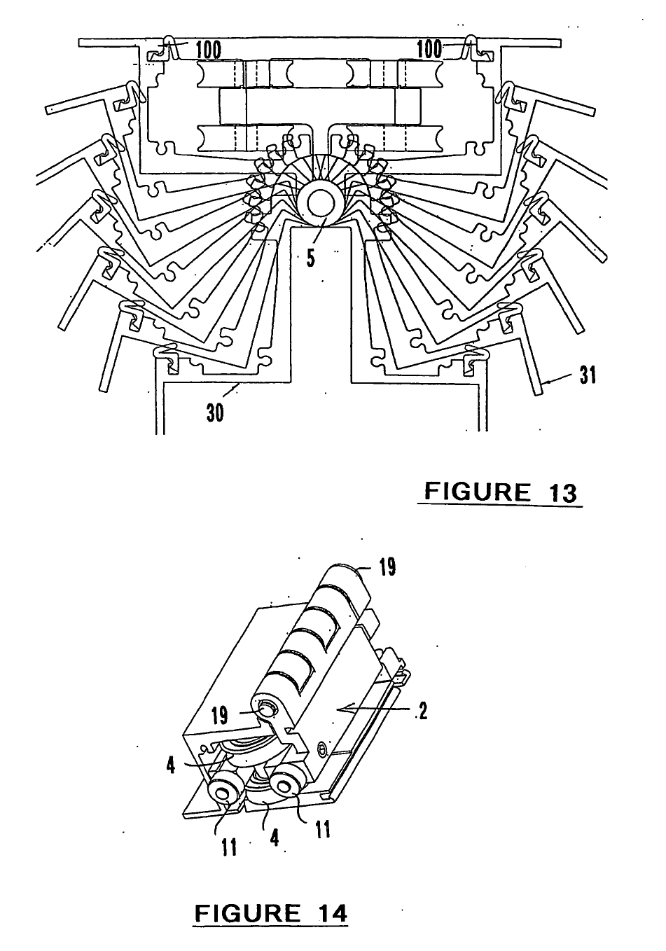

As shown in FIG. 13, the leaf edges (which in a preferred embodiment as shown comprise the seals 20) that contact the frame seals are off-set from the point of rotation of the leaves about pin 19. When the leaves are initially moved from a closed position to an open position their edges adjacent to the frame seals have a component of movement away from the frame seals at points 100. As can be seen, the edges of the leaves move away from the seals and do not have any significant component of movement along the seals, so there is no scrubbing. This is in contrast to existing constructions where the initial movement is along the frame seal, which causes a scrubbing problem.

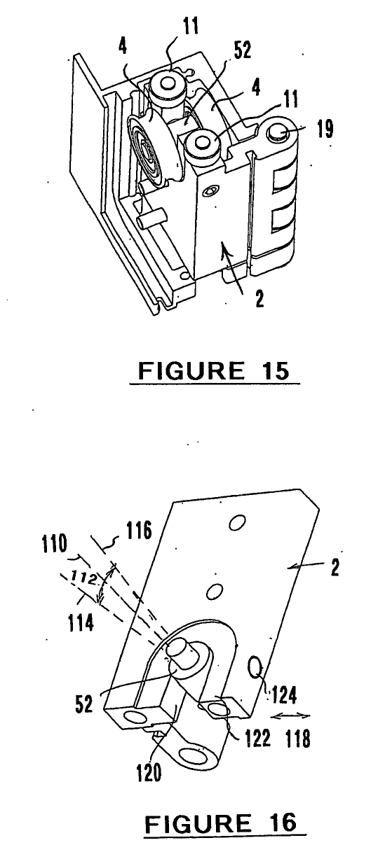

Referring now to FIGS. 14 to 17, an alternative bogey wheel assembly is shown. Features of the embodiment shown in FIGS. 14 to 17 which are the same as or similar to those of the embodiments discussed above have the same reference numerals.

In some multi-fold joinery assemblies the centre of mass of the joinery leaves moves away from the frame as the leaves assume an open position. Depending on the loads involved, this may exert a considerable turning moment on the bogey unit. Such turning moments may tilt or rotate the bogey unit, leaving only the wheel(s) on the outside of the unit in contact with the track.

The embodiment of FIGS. 14 to 17 allows the axle 52, and thus the wheels 4, to rotate relative to the bogey unit 11 approximately three degrees either side of horizontal in a plane perpendicular to the direction of motion of the bogey unit. This movement allows the wheels on both sides of the bogey unit to remain in contact with the track. The arc of movement is illustrated in FIG. 16 in which the chassis is shown having a recess 120 within which the axle 52 is disposed. The horizontal position of the axle is shown by line 110 and the approximately 6 degree arc of rotational movement is referenced 112 between lines 114 and 116. The arc of movement 112 is in a plane perpendicular to the direction of movement 118 of the bogey unit. Although only a single axle is shown, those skilled in the art will realise that multiple axles which are able to rotate as described above may be provided.

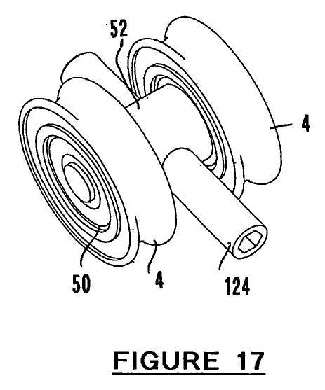

The chassis includes recesses 122 on either side to accommodate the wheel movement on axle rotation, and the axle includes a pivot pin (or projection) 124 at least one end of which is received in the chassis. The assembly of the wheels 4, axle 52 and pivot pin 124 is shown more clearly in FIG. 17.

The embodiment shown in FIGS. 14 to 17 may be used in conjunction with other embodiments described above to allow both wheels of the bogey unit to remain on the track 60 in response to rotational movement of the bogey unit.

This means that seal-to-seal friction and wear from scrubbing is eliminated. This has the advantage of reducing the need to replace seals as frequently as required with known constructions.

Furthermore, the reduction of seal/seal friction and/or scrubbing means that seals are more likely to function in their correct position. Damaged or worn seals have a tendency to bunch or sit in an undesirable or irregular position. This can allow air flow or draughts through the gap, and cause further damage to the seals. The present invention provides a means of extending the life of the seals 20 so that these problems may be avoided.

The current invention also provides a means of improving security and locking of a folding door assembly. The invention incorporates part of a bogey at the internal seal that runs parallel to the frame, such as wall segment 6 in the current example. This feature enables the fitting of lockable security bolts (for example bolt 85 in FIG. 4) to the outer surface of wall 6 i.e. the surface that faces interiorly toward the frame in use. The lockable bolt may be a slidable bolt which is slideable parallel to the stile and which can be slid into one or more apertures provided in the frame. Alternative locking devices that engage frictionally with the frame may also be provided. This enables the bogey to be locked to the frame at various positions along the length of the sill for example. This in turn means that the leaves can be securely locked at intermediate positions in the opening process (FIGS. 7 to 10) which allows ventilation with security.

Wherein the foregoing description reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention.

Throughout this document the word “comprise” and variations such as “comprises” and “comprising” is intended to be interpreted in an inclusive sense.

1. A joinery bogey for a multi-fold joinery leaf assembly having a plurality of joinery leaves provided in a frame, the joinery bogey including:
a body adapted to travel along a track mounted on the frame;
a pivot mount provided on the body for a pivot connection between the body and at least one of the leaves, the at least one leaf having a moveable edge proximal to the bogey, the moveable edge being provided adjacent to a frame seal for a head or sill of the frame when the at least one leaf is in a closed position, and the pivot connection being located so that the moveable edge has a component of movement away from the frame upon initiation of opening of the at least one leaf.

2. A joinery bogey as claimed in claim 1 including a wall segment provided on the body for location adjacent to the frame seal, and the at least one leaf being disposed about a periphery of the wall segment when the at least one leaf is in the closed position, the moveable edge comprising a part of the periphery.

3. A joinery bogey as claimed in claim 2 wherein the bogey is pivotally connected to the at least one leaf and regions of the leaf adjacent to the periphery of the wall segment are contoured or recessed such that the wall is substantially accommodated by the leaf when the leaf is in the closed position so that a substantially continuous planar surface is provided adjacent to the frame seal.

4. A joinery bogey as claimed in claim 2 or claim 3 wherein the wall segment has at least one vertical side and the moveable edge is provided adjacent to one of the vertical sides, the vertical side being horizontally displaced from the pivot connection.

5. A joinery bogey as claimed in any one of claims 2 to 4 wherein the wall segment includes two horizontal sides, one horizontal side being disposed above the level of the frame seal and the other horizontal side being disposed below the level of the frame seal.

6. A joinery bogey as claimed in any one of the preceding claims wherein the movement of the moveable edge away from the frame upon initiation of opening of the at least one leaf substantially prevents scrubbing between the moveable edge and the frame seal.

7. A joinery bogey as claimed in any one of the preceding claims wherein the moveable edge comprises at least part of a seal provided on the at least one leaf.

8. A joinery bogey as claimed in any one of the preceding claims in which the body includes one or more wheels which may rotate through an arc of movement in a plane perpendicular to the direction of travel of the bogey unit along the frame.

9. A multi-fold, joinery leaf assembly having two or more door or window leaves pivotally connected together about a vertical axis, a bogey unit pivotally connected to at least one of the leaves about a vertical axis and being adapted to travel along a track mounted on a frame, the at least one leaf having a moveable edge proximal to the bogey, the moveable edge being provided adjacent to a frame seal for a head or sill of the frame when the at least one leaf is in a closed position, and the pivot connection being located so that the moveable edge has a component of movement away from the frame upon initiation of opening of the at least one leaf.

10. An assembly as claimed in claim 9 wherein the bogey unit is provided with a wall segment for location adjacent to the frame seal, and the at least one leaf is disposed about a periphery of the wall segment when the at least one leaf is in the closed position, the moveable edge comprising a part of the periphery.

11. An assembly as claimed in claim 10 wherein regions of the at least one leaf adjacent to the periphery of the wall segment are contoured or recessed such that the wall is substantially accommodated by the leaf when the leaf is in the closed position so that a substantially continuous planar surface is provided adjacent to the frame seal.

12. An assembly as claimed in claim 10 or claim 11 wherein the wall segment has at least one vertical side and the moveable edge is provided adjacent to one of the vertical sides, the vertical side being horizontally displaced from the pivot connection between the bogey and the at least one leaf.

13. An assembly as claimed in any one of claims 10 to 12 wherein the wall segment includes two horizontal sides, one horizontal side being disposed above the level of the frame seal and the other horizontal side being disposed below the level of the frame seal.

14. An assembly as claimed in any one of claims 9 to 13 wherein the track is provided in a sill of the frame and the at least one leaf is provided directly over the track.

15. An assembly as claimed in any one of claims 9 to 14 wherein the bogey unit includes the pivot connection, and the bogey unit further includes one or more stile or rail engaging arms which connect the bogey unit to a stile or rail of the at least one leaf.

16. An assembly as claimed in any one of claims 9 to 15 comprising a plurality of extruded components.

17. An assembly as claimed in any one of claims 9 to 16 wherein the track is replaceable in the frame.

18. An assembly as claimed in any one of claims 9 to 17 wherein wherein the movement of the moveable edge away from the frame upon initiation of opening of the at least one leaf substantially prevents scrubbing between the moveable edge and the frame seal.

19. An assembly as claimed in any one of claims 9 to 18 wherein the moveable edge comprises at least part of a seal provided on the at least one leaf.

20. An assembly as claimed in any one of claims 9 to 19 in which the bogey unit includes one or more wheels which may rotate through an arc of movement in a plane perpendicular to the direction of travel of the bogey unit along the frame.

21. A joinery bogey for a multi-fold joinery leaf assembly, the bogey unit including:
a track movement means to allow the bogey to move along a track;
a pivot assembly pivotally connecting one or more stile or rail engaging arm to the bogey unit, each stile or rail engaging arm being adapted to be attached to a stile or rail of a joinery leaf.

22. A joinery bogey as claimed in claim 21 wherein a further stile or rail engaging arm is pivotally connected to the bogey unit by the pivot assembly.

23. A joinery bogey as claimed in claim 21 or claim 22 wherein the stile or rail engaging arm is adapted to be attached to the stile or rail of a leaf by being received within a cavity provided in the stile or rail.

24. A track assembly for a multi-fold joinery leaf installation having an extruded frame member with a recess adapted to receive a track, the track being insertable and removable to and from the recess and having at least one wall defining a central cavity and two edges, at least one of the edges being adapted to support a bogey unit.

25. A track assembly as claimed in claim 24 wherein the at least one edge includes a lip or bead providing a substantially convex surface.

26. A track assembly as claimed in claim 24 or claim 25 wherein the track includes a coating to reduce wear.

27. A track assembly as claimed in claim 24 or claim 25 wherein the track is formed from a different material than the frame.

28. A track assembly as claimed in any one of claims 22 to 27 wherein the frame member is formed from aluminum and the track is formed from stainless steel.

29. A track assembly as claimed in any one of claims 24 to 28 wherein the cavity is adapted to accommodate a guide member dependent from the bogey unit.

30. A track assembly as claimed in any one of claims 24 to 29 wherein the bogey unit is provided clear of a base of the cavity so that the cavity in use allows particulate matter to fall therein so as to prevent the particulate matter from interfering with movement of the bogey unit along the track.

31. A kit of parts for providing a construction as claimed in any one of the foregoing claims.

32. A joinery bogey substantially as herein described with reference to any one of the examples and the accompanying drawings.

33. A multi-fold, joinery leaf assembly substantially as herein described with reference to any one of the examples and the accompanying drawings.

34. A track assembly for a multi-fold joinery leaf installation substantially as herein described with reference to any one of the examples and the accompanying drawings.
